(19) United States
(12) Patent Application Publication
(10) Pub. No.: US 2006/0061063 A1
(43) Pub. Date: Mar. 23, 2006

(54) Pull master

(76) Inventor: Daniel Patrick Lopez, Norwalk, CA (US)

Correspondence Address: Daniel Patrick Lopez, 12011 Fairford Ave, Norwalk, CA, 90650, US

(21) Appl. No.: 10/945,521

(22) Filed: Sep. 20, 2004

(51) Int. Cl. B60P 3/071

(52) U.S. Cl. 280/504

(57) ABSTRACT

PULL MASTER DUAL tow hitch hook a new creation tool made from a 10 inch Piece of square steel tubing (2×2×¼ inch) with two steel hooks each rated at 10,000 pounds of tensile strength welded on the top and bottom of the square steel tubing. PULL MASTER QUAD is a 10 inch piece of square steel tubing (2×2×¼ inch) with four steel hooks rated at 10,000 pounds of tensile strength for each hook welded on each side of the steel square tubing. Material used to assemble tool is an argon gas mig welder with 0.035 steel wire or 6013 high tensile welding rod.

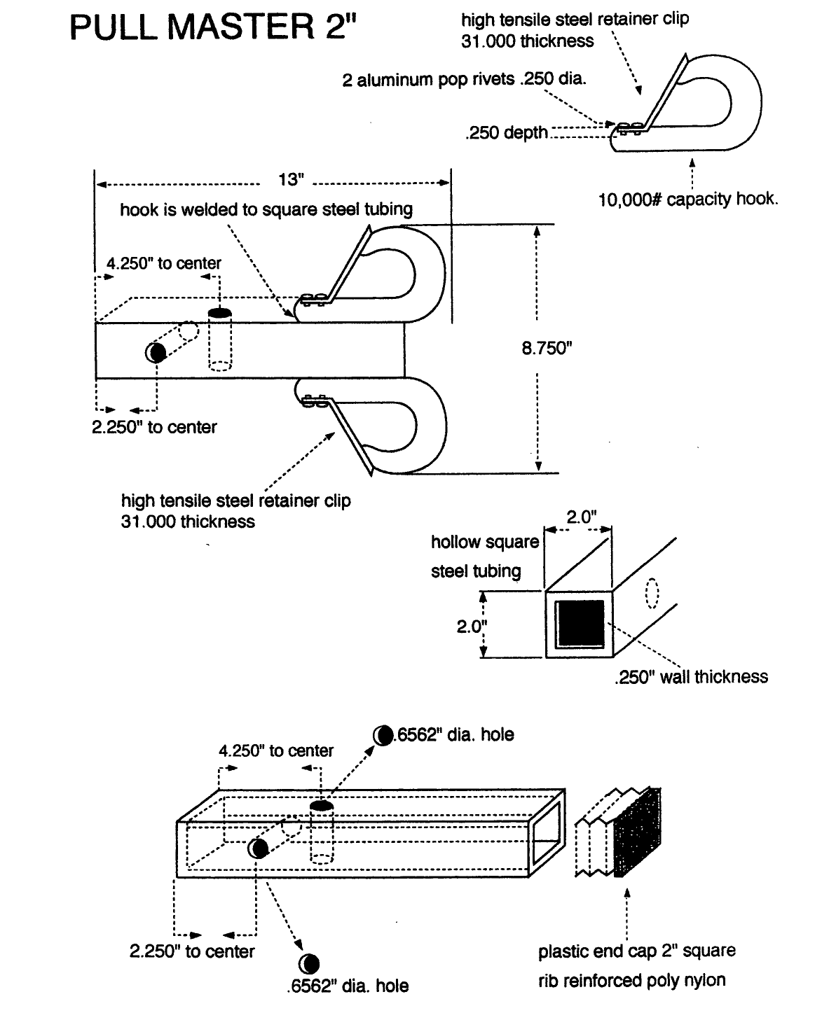

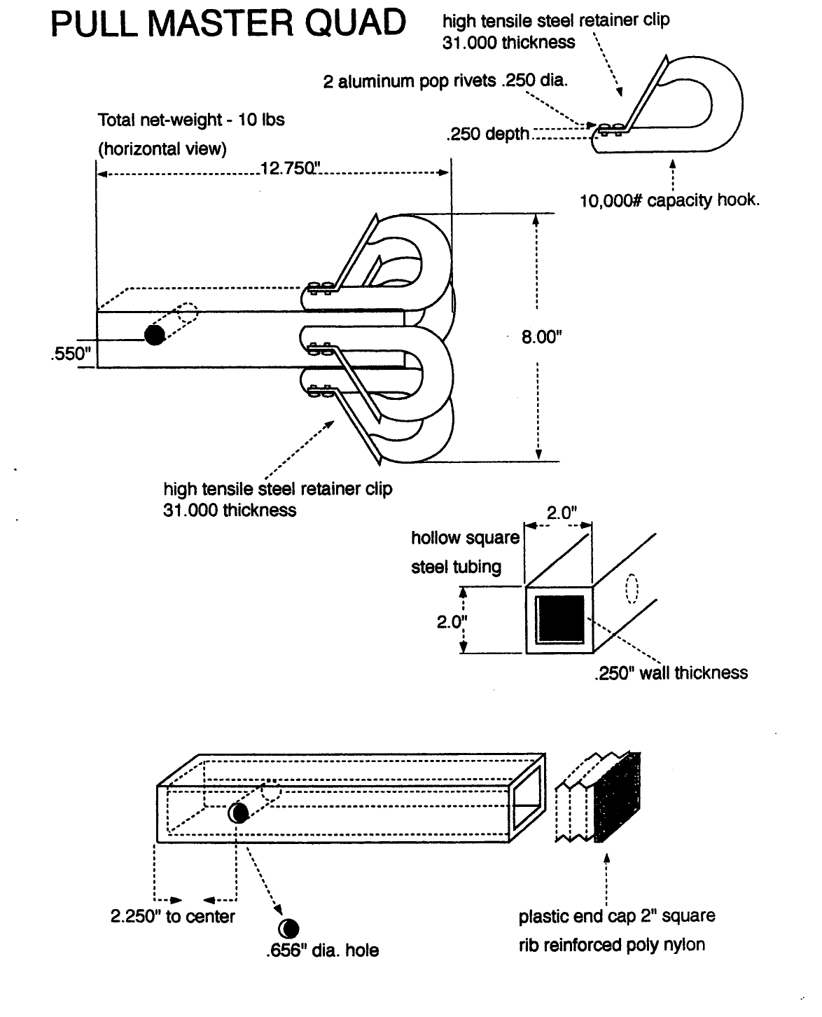

Pull masters added features are using the tool in horizontal or vertical positions. compact in size. Dual Pull Master weight is 8 pounds. Pull Master Quad is 10 pounds. Pull Master was designed for use in off road vehicles in most mud and snow conditions. Pull Master can be used on SUV's, pickups, cars, rescue vehicles, construction, farming, ranching and landscape vehicles with a 2×2×¼ inch tow hitch receiver. Pull Master can be used with any chain, cable or towing harness.

Pull Master is a unique newly created tow hitch accessory that is unlike any other hitch accessory used in the past or is available for today's use. Pull Master can be used in any standard 2 inch tow hitch receivers. Its concept in design is totally new, the Pull Master can be used in vertical or horizontal positions. It offers an exciting variety of uses for what ever you pull or tow in an emergency. Pull master can be used to pull or tow with a chain, rope or cable. Pull master is compact in design and it offers brute strength. Has ideal use on ranches, farms, mud and snow conditions. It is a valuable tow hitch accessary to be used in the construction trade. Pull Master can easily be packed away in your personal car, truck, motor home, SUV and off road vehicles. Pull master is durable and designed for long lasting heady duty use.

1. This application claim is for my provisional application No. 60/508,245 filed on Oct. 3, 2003 that is for my invention of the tow hitch Pull ester. I am filing for a utility patent application for this tool.
The tow hitch, Pull Master, is a completely newly designed accessory tool, with an added feature of being invertible in use of its hooks. This tool is made for the use on cars, pickups, motor homes, SUVS and off road vehicles with any standard 2 inch tow hitch receiver.
tow hitch Pull Master has the availability of multiple uses such as road emergencies, construction, landscape, rescue operation, off road vehicles, etc. This tool design is one of its kind in existence.
Both tow hitches hooks; the dual and the quad are made of quarter inch square steel tubing and high strength steel hooks that are rated at 10,000 pounds of tensile strength each.
